(19) United States
(12) Patent Application Publication
(10) Pub. No.: US 2016/0298375 A1
(43) Pub. Date: Oct. 13, 2016

(54) PARTITION MOUNTING SYSTEM WITH CLAMP CAPTURE SHOE

(71) Applicant: R & B Wagner, Inc., Butler, WI (US)

(72) Inventors: Robert Wagner, Milwaukee, WI (US); Richard A. Kettler, Milwaukee, WI (US); Andrew Chatfield, Port Washington, WI (US); Justin Wesser, Menomonee Falls, WI (US); Kurt Turdo, Menomonee Falls, WI (US)

(73) Assignee: R & B WAGNER, INC., Butler, WI (US)

(21) Appl. No.: 14/680,786

(22) Filed: Apr. 7, 2015

(51) Int. Cl. E06B 3/54; E04F 11/18

(52) U.S. Cl. CPC E06B 3/5454; E04F 11/1851

(57) ABSTRACT

A system for mounting a partition, the system including a shoe with a slot for receiving an edge of the partition and an isolator that fits within the slot between the partition and a portion of the slot. A clamp assembly fits within the slot opposite the first isolator. The clamp assembly includes a block with a projection on the side thereof facing a shoe sidewall. The shoe sidewall face adjacent to the block has a groove capable of receiving a projection therein so that when the projection is received in the groove, the block is not movable in a partition-withdrawal direction across the shoe sidewall face. The clamp assembly also includes a panel edge receiving pocket adapted to receive and hold the bottom of the panel lower edge and the sides of the panel lower edge.

### FIELD OF THE INVENTION

The present disclosure relates generally to mounting systems and clamp assemblies for mounting partitions.

### BACKGROUND

It is conventional to use glass or glass-like transparent or semi-transparent partitions as part of a guard rail, hand rail or other railing for a stair or for a walkway. To mount these partitions securely without damaging the glass itself has always been an issue with installation of such partitions. In addition, it may be desirable to provide for removal of the partition, without damaging the partition, for repair or replacement at some future date.

One conventional system for installing and removably securing partitions in such applications is shown in U.S. Pat. No. 7,730,682, the disclosure of which is incorporated herein by reference.

Improvements to the above-referenced system and other known approaches to installing and removably securing partitions are desirable.

### SUMMARY OF THE INVENTION

The present disclosure relates to a system for mounting a partition. The partition mounting system includes a shoe with a slot for receiving an edge of the partition and a first isolator that fits within the slot, between the partition and a portion of the shoe. A clamp system fits within the slot opposite the first isolator. The clamp system includes upper and lower blocks and, optionally, one or more center blocks. Surfaces of the blocks are angled with respect to each other so that drawing the upper and lower blocks toward each other will urge one of the blocks in one direction and the other block or blocks in the opposite direction. The clamp system includes engagement surfaces which engage a side wall of the shoe and a side of the partition so as to, by friction, selectively and releasably hold the partition within the slot. At least one of the blocks also includes a projection on the side thereof, facing one of the sidewalls of the shoe. The shoe sidewall face adjacent to that block has a groove capable of receiving a projection therein so that, when the projection is received in the groove, the block is not movable in a partition withdrawal direction across the shoe sidewall face. The clamp assembly also includes a panel-edge-receiving pocket, or isolator, adapted to receive and hold the bottom and sides of the lower edge of the panel.

Other objects and advantages of the invention will become apparent hereinafter.

### BRIEF DESCRIPTION OF THE DRAWINGS

The accompanying drawing figures, which are incorporated in and constitute a part of the description, illustrate several aspects of the invention and together with the description, serve to explain the principles of the invention. A brief description of the figures is as follows:

FIG. 1 is an end cross-sectional view of a partition clamping system constructed according to one embodiment of the present invention.

FIG. 2 is an end view of a partition mounting shoe of the partition clamping system shown in FIG. 1.

FIG. 3 is a side view of a center block of the partition clamping system shown in FIG. 1.

FIG. 4 is a top view of the center block shown in FIG. 3.

FIG. 5 is an end view of the center block shown in FIG. 3.

FIG. 6 is a side view of a lower block of the partition clamping system shown in FIG. 1.

FIG. 7 is a top view of the lower block shown in FIG. 6.

FIG. 8 is an end view of the lower block shown in FIG. 6.

FIG. 8A is a bottom view of a lower block of the partition clamping system shown in FIG. 1, with a nut received in a nut receiving opening.

FIG. 8B is a rear perspective view of the lower block shown in FIG. 8A, with a nut captured in a nut receiving opening in the lower block.

FIG. 8C is a rear perspective view of a lower block shown in FIG. 8A, without the nut shown in FIG. 8B.

FIG. 8D is a front perspective view of the lower block shown in FIG. 8A, including the nut shown in FIG. 8B.

FIG. 9 is a side view of an upper block of the partition clamping system shown in FIG. 1.

FIG. 10 is a bottom view of the upper block shown in FIG. 9.

FIG. 11 is an end view of the upper block shown in FIG. 9.

FIG. 12 is a side view of an isolator of the partition clamping system of FIG. 1.

FIG. 13 is an end view of the isolator shown in FIG. 12.

FIG. 14 is a side view of a second isolator of the partition clamping system shown in FIG. 1.

FIG. 15 is a top view of the second isolator shown in FIG. 14.

FIG. 16 is an end view of the second isolator shown in FIG. 14.

FIG. 17 is a perspective view of a partition mounted using the mounting system of the present invention.

FIG. 18 is an exploded perspective view of the partition shown in FIG. 17.

FIG. 19 is an enlarged end view of the mounting system according to another embodiment of the present invention, showing some of the parts of the clamp and isolator.

FIG. 20 is an enlarged end view of the mounting system according to another embodiment of the present invention, showing some of the parts of the clamp and isolator.

FIGS. 21 and 22 are perspective end and side views of portions of two shoes about to be attached to one another.

FIGS. 23 and 24 are perspective end and side views of portions of the two shoes shown in FIGS. 21 and 22, more fully assembled.

FIG. 25 is an end view of the shoe shown in FIG. 24, with a tapered pin placed in an opening in the shoe.

FIGS. 25A and 25B are side and rear views of a clamp assembly constructed according to another embodiment of the invention.

FIGS. 26A, 26B and 26C are perspective, side and rear views of a clamp assembly constructed according to another embodiment of the invention.

FIGS. 27A, 27B and 27C are perspective, side and rear views of another clamp assembly, constructed according to yet another embodiment of the invention.

### DETAILED DESCRIPTION

Reference will now be made in detail to exemplary aspects of the systems which are illustrated in the accompanying drawings. Wherever possible, the same reference numbers will be used throughout the drawings to refer to the same or like parts.

Referring now to the drawing figures, a system 100 is illustrated for clamping a partition 102, such as for use in a hand rail, guard rail or other railing system, into a base or shoe 104 is shown. Shoe 104 defines a slot 106 within which a lower edge 108 of partition 102 is received. Slot 106 includes a pair of opposing interior side walls 110 and a lower wall 112. Partition 102 includes a pair of opposing sides 114 adjacent to lower edge 108. Within slot 106 between one of the sides 114 and one of the side walls 110 is at least a portion of a first isolator 116. Isolator 116 may include a vertical portion 118 (between side 114 and side wall 110) and a lower portion 120 (between lower edge 108 and lower wall 112).

Between opposite side 114 and opposite side wall 110, a clamp assembly 122 is positioned within slot 106. Clamp assembly 122 is configured to be selectively expandable to provide force against both side wall 110 and side 114. Such force may act upon a second isolator 142 to apply pressure against side 114 of partition 102 and prevent removal of partition 102 from slot 106 of shoe 104. Clamp assembly 122 includes at least an upper and a lower block.

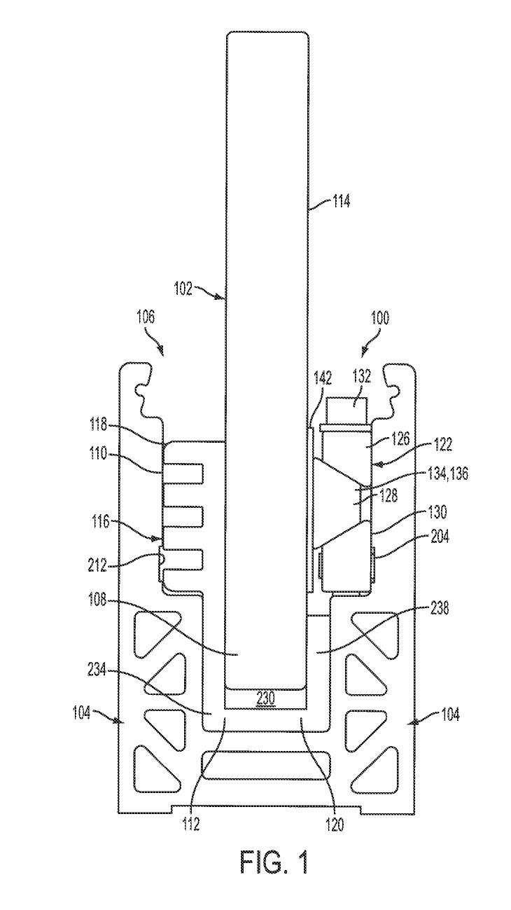

In the embodiment shown in FIGS. 1, 3-11, 19 and 20, clamp assembly 122 includes an upper block 126, a center block 128 and a lower block 130. A screw 132 extends through all three blocks, generally vertically. An upper surface 134 of center block 128 and a lower surface 136 of upper block 126 are sloped with respect to horizontal and may be generally sloped the same degree as each other. A lower surface 138 of center block 128 and an upper surface 140 of lower block 130 are sloped with respect to horizontal and may be generally sloped the same degree as each other. Having the upper and lower sloped surfaces of center block 128 sloped oppositely, as shown, use of the screw 132 to pull upper block 126 toward lower block 130 will urge center block 128 in a direction transverse to the length of the screw. In FIG. 1, the center block 128 is urged toward partition 102, but it could just as easily be oriented the opposite way to be urged toward the adjacent side wall 110 of shoe 104. As center block 128 is urged in one direction, upper and lower blocks 126 and 130 will be urged in the opposite direction. Again, in FIGS. 1, 19 and 20, that direction is toward the adjacent side wall 110 of shoe 104, but it could be oriented oppositely, urged toward partition 102 (FIG. 1). The second isolator 142 may be positioned between center block 128 and side 114 of partition 102.

Cooperation between isolators 118 and 142, and clamp assembly 122 may allow partition 102 to be laterally positioned as desired within slot 106. As shown, partition 102 is generally centered within slot 106. It may be desirable to have partition 102 centered, or offset closer to one or the other of the side walls 110. Appropriate selection of the thickness of the isolators may permit or facilitate some degree of offset.

Isolators 118 and 142 may be preferably made of a malleable material that may conform to the surface of sides 114 of partition 102. Use of such compliant materials for the isolators will permit more durable and rigid materials to be used to form clamp assembly 122 as these harder materials are not in contact with the material of partition 102 and thus cannot scar, scratch, score or otherwise harm the aesthetics or integrity of the partition. The shoe 104 may be configured to be mounted to a supporting surface by any suitable permanent or removable means without departing from the scope of this description.

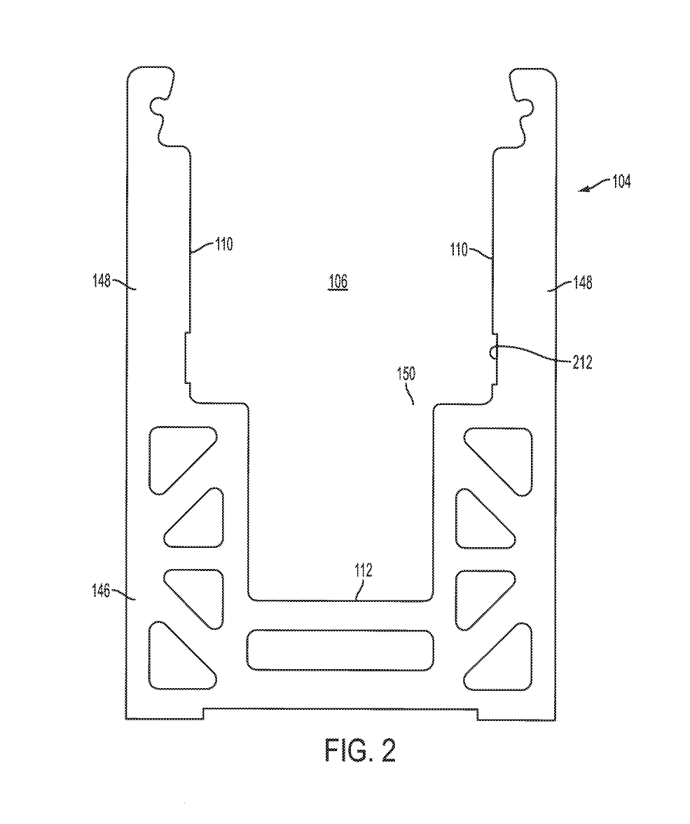

Referring now to FIG. 2, shoe 104 may include a base 146, with lower wall 112, and a pair of upward extensions 148 of which side walls 110 define inner surfaces thereof. The spacing between side walls 110 may be varied as desired to accommodate different widths of partition 102 and of isolators 118 and 142. Lower wall 112 may be within a recess 150 within slot 106, or the lower wall may form the entire bottom of slot 106. Shoe 104 extends for an indeterminate length, as only the cross-sectional view is shown in FIGS. 1 and 2 to convey the unique aspects of this description. Such extension is similar to conventional mounting bases or shoes for mounting partitions.

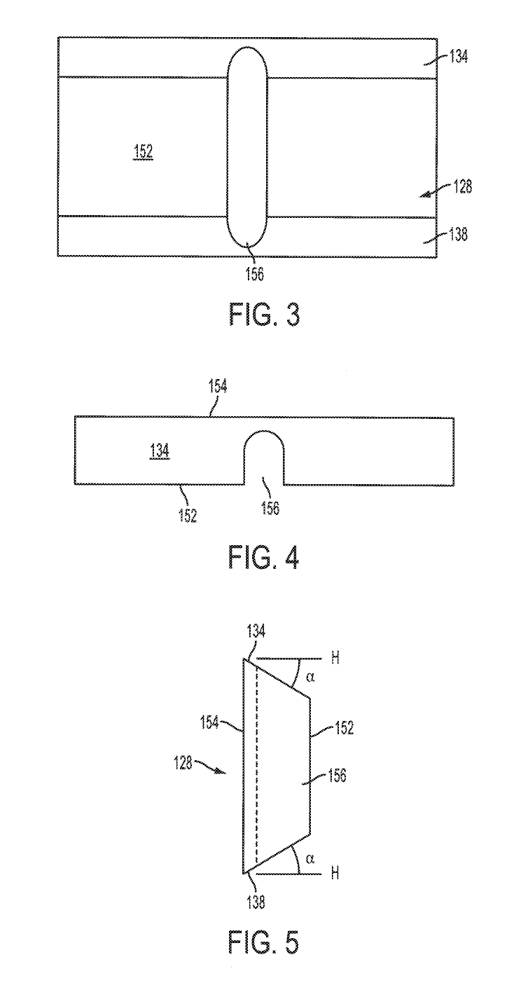

Referring now to FIGS. 3 to 5, in the embodiment shown, center block 128 includes a first side 152 and a second side 154. First side 152 may include a groove or recess 156 for receiving screw 132. While groove 156 is shown as an open sided recess, such an open form is not necessary. An opening elongated between the first and second sides that will permit center block 128 to move in the direction of either side 152 or 154 when the position of upper and lower blocks is altered may also permit the clamp assembly 122 according to this description to function as described herein. Second side 154 also defines an engagement surface that engages and applies pressure against the partition, either directly or indirectly through an isolator.

As shown in FIG. 5, upper surface 134 and lower surface 138 are angled with respect to a horizontal line (labeled H in the figure). This angle (labeled a) is preferably generally the same for both surfaces, although the angles are defined in opposing directions. The angles of the two different surfaces may also be different from each other within the scope of the invention. Angle α is shown as approximately thirty degrees, although other similar angles may be used within the scope of the invention.

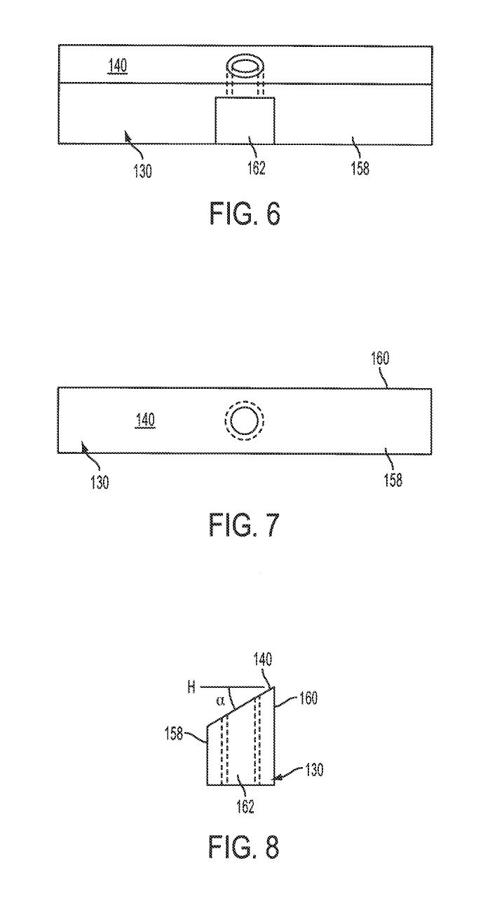

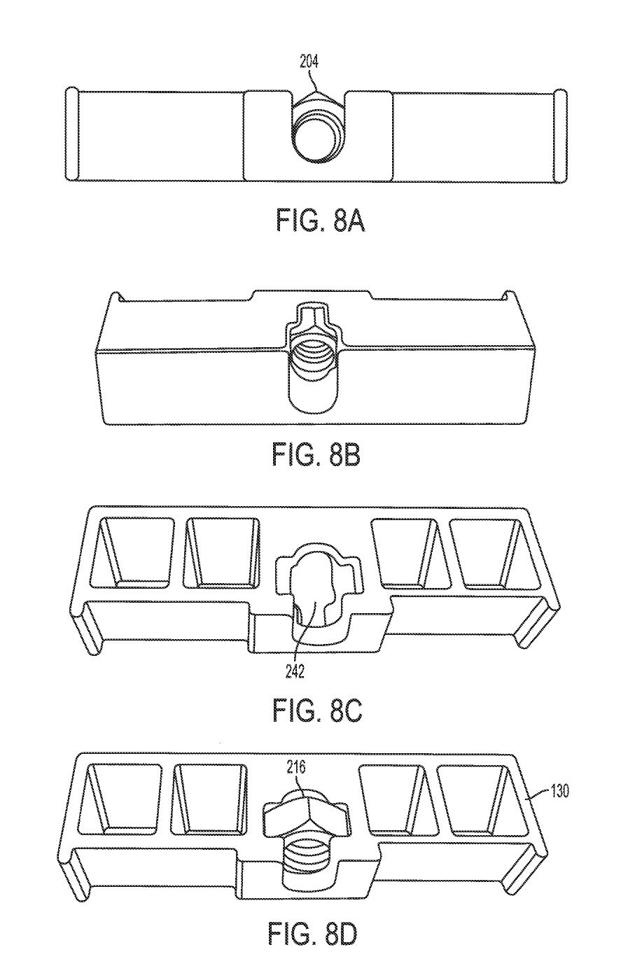

Referring now to FIGS. 6 to 8, lower block 130 includes a first side 158 and a second side 160. Second side 160 also defines an engagement surface to engage side walls 110 within slot 106. An opening 162 is provided through upper surface 140 to receive a threaded lower end of screw 132. As shown in FIG. 8, upper surface 140 is angled at generally the same angle α with the horizontal H, as the angle α described with respect to FIG. 5, although the angles of the two surfaces do not necessarily need to be identical.

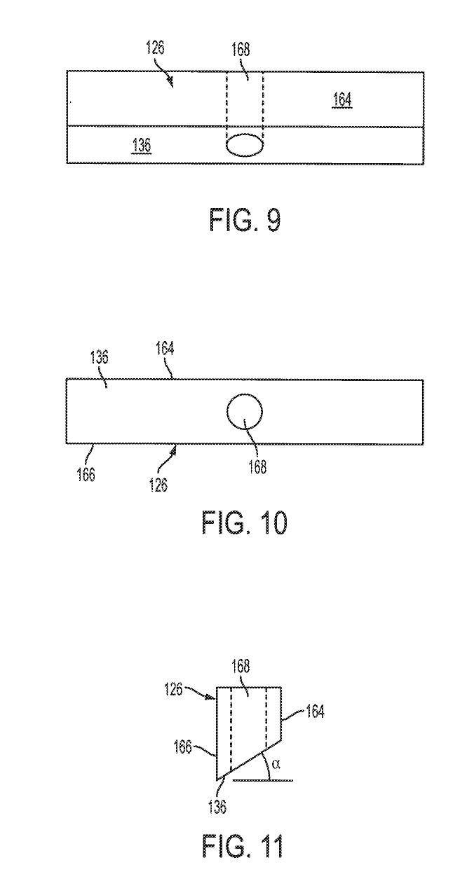

Referring to FIGS. 9 to 11, upper block 126 includes a first side 164 and a second side 166. Second side 166 also defines an engagement surface to engage side walls 110 within slot 106. An opening 168 is provided through lower surface 136 to receive an upper end of screw 132. Here again, as shown in FIG. 11, lower surface 136 is angled at generally the same angle α with the horizontal H as the angle α described with respect to FIG. 5, although the angles of the two surfaces do not necessarily need to be identical.

The fact that angles α between lower surface 138 and upper surface 140 are non-zero will urge center block 128 and lower block 130 in opposite directions when screw 132 pulls upper and lower blocks 126 and 130 toward each other and also maintain the alignment of engagement surfaces 160 and 154 of the lower and center blocks as the blocks are urged in opposite directions. Similarly, the general matching of angles α between upper surface 132 of center block 128 and lower surface 134 of upper block 126 will tend to maintain the alignment of engagement surfaces 154 and 166, of the central and upper blocks as the blocks are urged in opposite directions. Having upper and lower blocks 126 and 130 with the same angle α with regard to the sloped upper and lower surfaces of center block 128 will also help maintain a consistent angle of engagement surface 160 and 166 with regard to each other as they engage side wall 110 of slot 106.

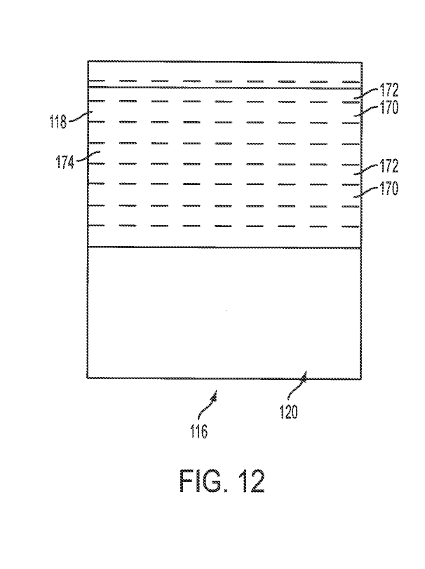

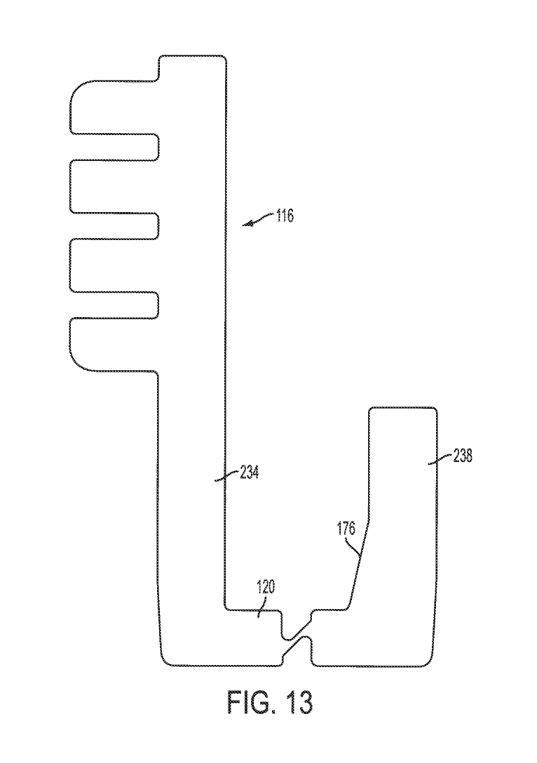

Referring now to FIGS. 12 and 13, vertical portion 118 of first isolator 116 may be joined to lower portion 120 by a living hinge or other integral connection. Alternatively, the vertical and lower portions may be separate elements or they may be joined by a separate piece, but it is preferable to have isolator 116 comprised of these two elements linked together for ease of handling and installation. Vertical portion 118 includes an outer surface 170 configured to engage side wall 110 of slot 106. As shown, a number of grooves 172 may be formed in the outer surface to reduce the amount of material required to form the isolator, which may in turn result in a lower production costs and a lighter isolator. Opposite the outer surface is an inner surface configured to engage side 114 of partition 102. An inner surface of lower portion 120 is configured to engage lower edge 108 of partition 102. The side of isolator 116 facing vertical portion 118 may be angled as shown at 176, that is, thinner at the top than at the bottom. The isolator 116 thus presents a wider top opening for receiving the panel lower edge 108 and a narrower bottom opening for holding the panel lower edge 108. As a result of the wider top opening, the panel lower edge 108 can easily enter the clamp assembly 122, but once the panel lower edge is seated in the pocket 230, the panel lower edge 108 is held snugly in the clamp assembly 122. Isolator 116 is preferably made of a malleable material that may conform to the surface of sides 114 of partition 102.

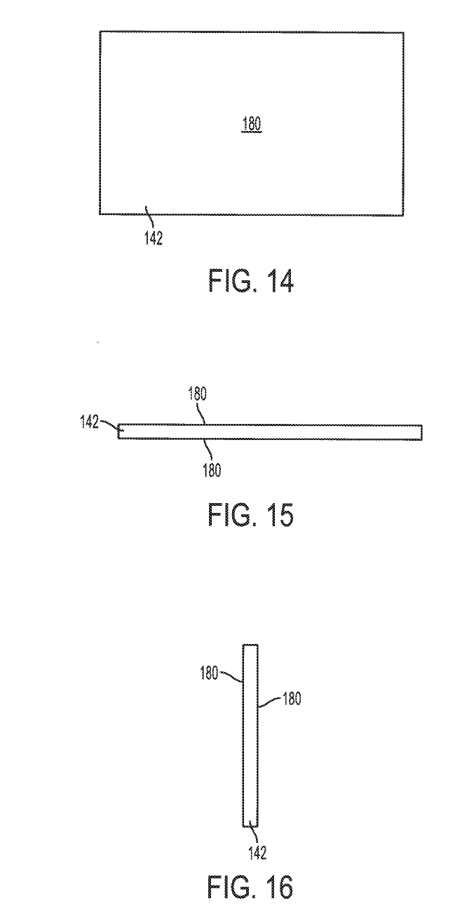

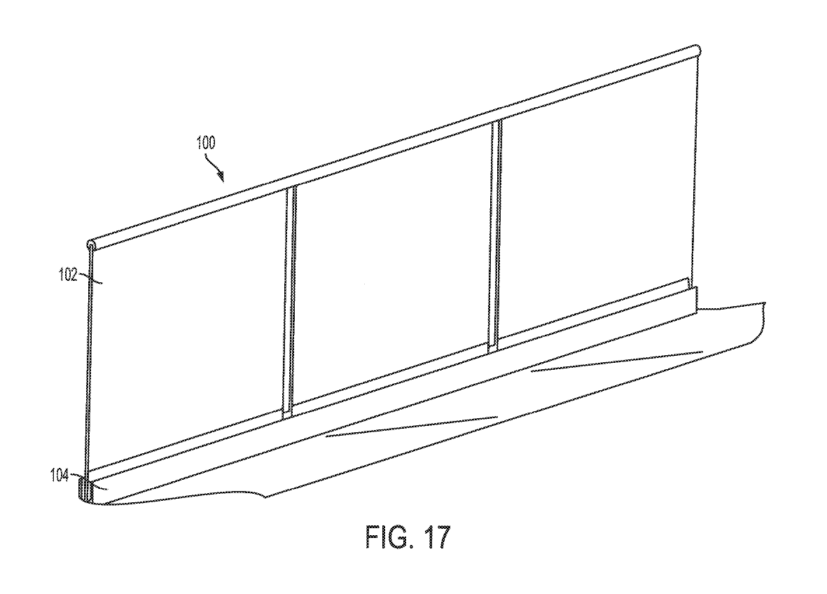

FIGS. 14 to 16 illustrate isolator 142 for placement between engagement surface 154 of center block 128 and side 114 of partition 102. Isolator 142 is a simple rectangular solid of material with opposing side surfaces 180 configured to engage either engagement surface 154 or side 114. Isolator 142 is preferably at least as large as engagement surface 154 (FIGS. 4 and 5) and may be oversized as compared to this surface 154.

Isolators 116 and 142 cooperate with clamp system 122 to position partition 102 within slot 106. The thickness of the isolators may also be varied to accommodate thicker or thinner partitions 102 or lower edges 108 within the same size shoe 104. For example, two common glass partition sizes are nominally one half inch and three quarters of an inch. Use of different thicknesses of isolators and a sufficiently wide slot 106 will permit the same shoe 104 to accommodate and clamp both of these standard sizes and ensure that the partition is centered within the slot.

The improved system 100 has an improved clamp assembly 122, the clamp assembly comprising a projection 204 on the side thereof facing a shoe sidewall 110. In the embodiment shown in FIGS. 8A-8D, the projection 204 projects from lower block 130. The shoe sidewall face 208 adjacent to the lower block 130 has a groove 212 capable of receiving a projection 204 therein, so that when the projection 204 is received in the groove 212, the clamp assembly 122 is not movable in a partition-withdrawal direction (upward in the drawings) across the shoe sidewall face 208.

More particularly, in the embodiment shown in FIGS. 8A-8D, the lower block 130 includes a captured nut 216 that is threaded onto the lower end of the screw 132, the nut 216 having a corner 204a that protrudes from the side of the lower block 130. As shown in FIGS. 8A-8D, the nut 216 is captured in an opening 242, which may also be referred to as a lower block nut receiving opening. Besides permitting a corner 204a of the nut 216 to protrude, the opening 242 is configured to prevent rotation of the nut within the lower block 130. The shoe sidewall face 208 adjacent to the lower block 130 has the groove 212 therein, so that when the nut corner 204a is received in the groove, the lower block is not movable in a partition-withdrawal direction across the shoe sidewall face 208. Prior to the tightening up of the clamp assembly 122 by turning the screw 132 in the nut 216, the lower block 130 is spaced apart from the shoe wall 110, so the clamp assembly can still be moved across the shoe sidewall face 208, that is, into and out of the shoe 104, since the nut corner 204a is not yet received in the side wall grove 212.

In other embodiments, as described below, the projection from the side of the lower block can take other forms, such as being an outwardly extending flange molded into the side of the lower block, for example.

Both shoe inside sidewall faces 208 have a groove 212 capable of receiving a projection 204 therein, so that the clamp assembly 122 can be placed on either side of the partition 102 and shoe 104.

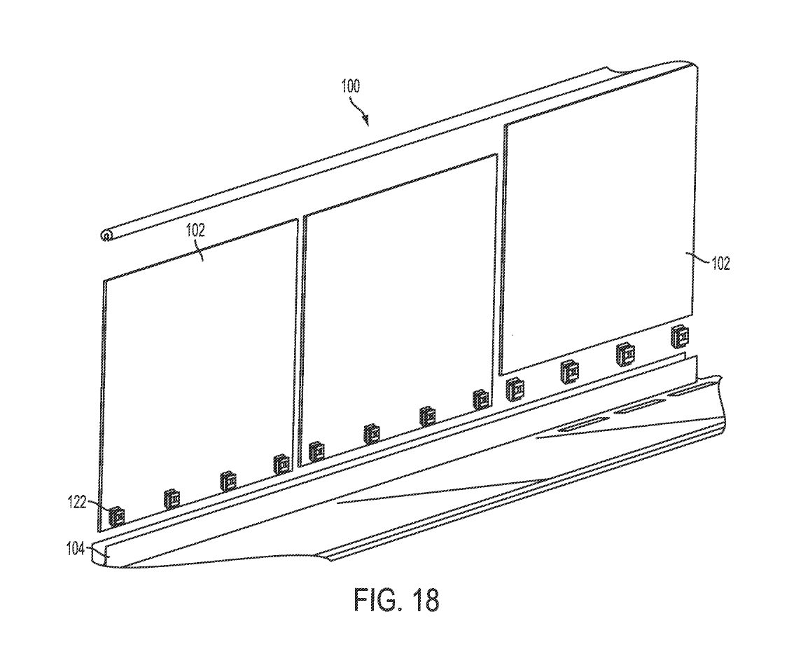

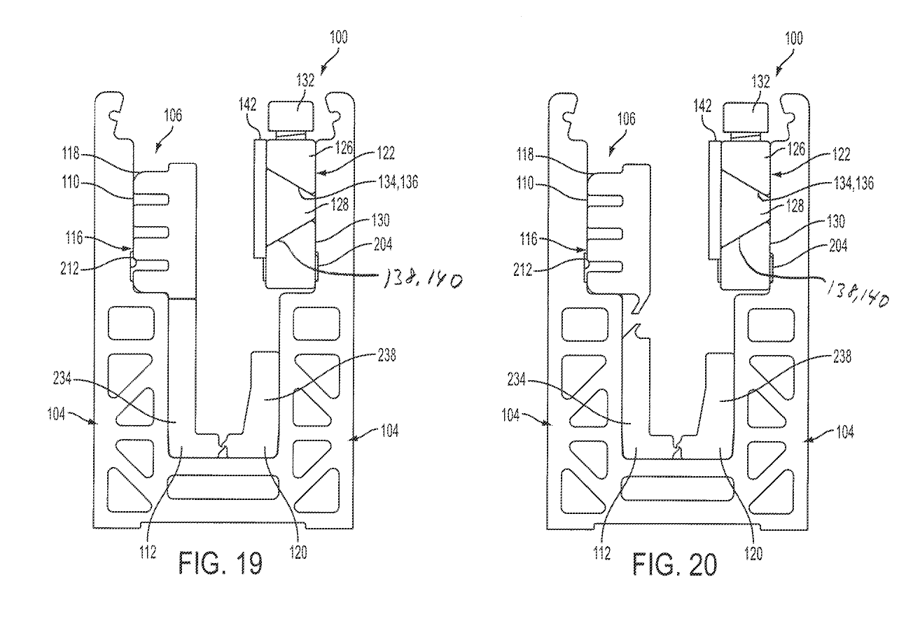

The improved clamp assembly 122 may further include a first isolator 116 that includes a panel-edge-receiving pocket 230, adapted to receive and hold the bottom of the panel lower edge 108 and both sides of the panel lower edge 108. The pocket 230 has the lower portion 120 and spaced apart vertical portions 234 and 238 attached to the lower portion. The vertical portions 234 and 238 may be joined to the lower portion 120 by a living hinge or other integral connection or reduced connecting portion. Alternatively, the vertical and lower portions may be separate elements or they may be joined by a separate piece, but it is preferable to have isolator 116 comprised of these three elements linked together for ease of handling and installation. As illustrated in FIGS. 13 and 19, in some embodiments, the lower portion 120 may also have a living hinge reduced connecting portion within its length. As shown in FIG. 20, the vertical portion 234 may also have a living hinge or reduced connecting portion formed within its length. These living hinges or reduced connecting portions may be separable, that is, capable of being broken apart at that spot, as one is shown in FIG. 20, such that additional width of the partition 102, or additional depth of the slot 106, may be accommodated by breaking or separating at the reduced portion.

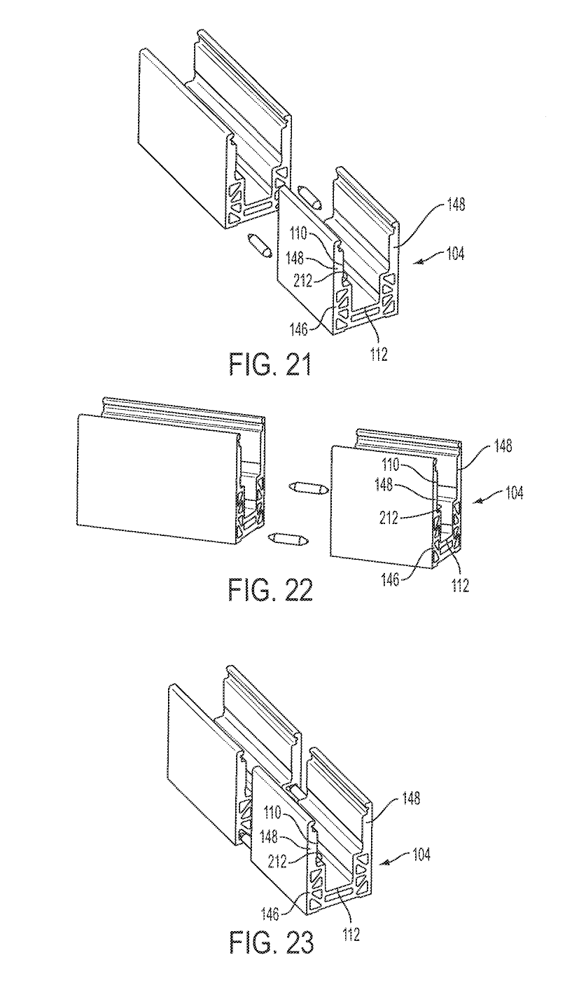

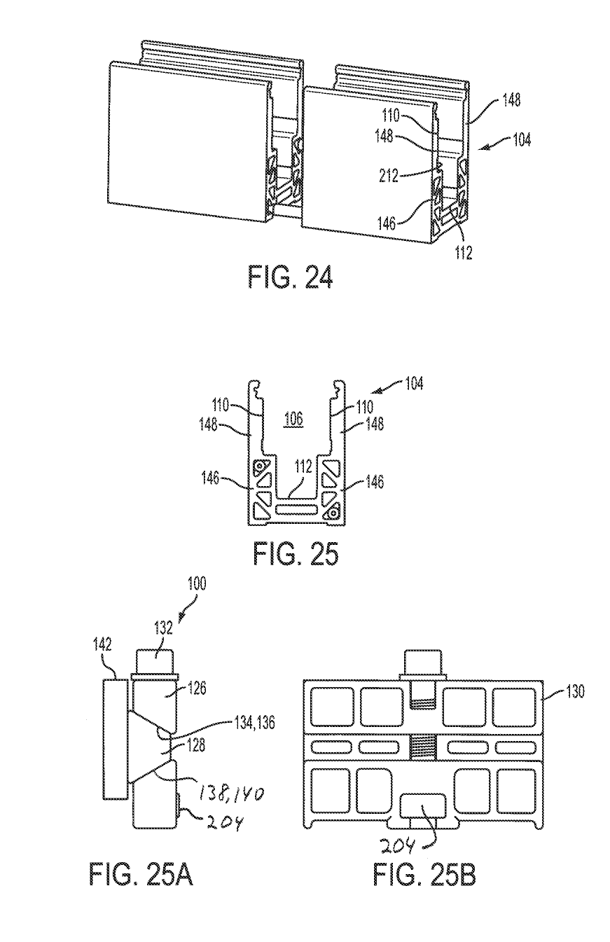

As illustrated in FIG. 1, the shoe is made from extruded aluminum including several openings that extend the longitudinal length of the shoe. This has several advantages. The extrusion is lighter than a comparable solid shoe. Further, for long panel spans, more than one elongated shoe can be used, with subsequent shoes being placed adjacent to but aligned with the prior shoe. To assist in connecting and aligning the shoes, a shoe alignment and connection system is illustrated in FIGS. 21 through 25. The shoe alignment and connection system includes at least one, and preferably two, tapered pins that extend between adjacent shoes, the pins being received in aligned openings in the adjacent shoes. The pins serve to align the shoes as they are brought together, and to hold the shoes so that they cannot be separated in a direction traverse to the longitudinal axis of the shoes.

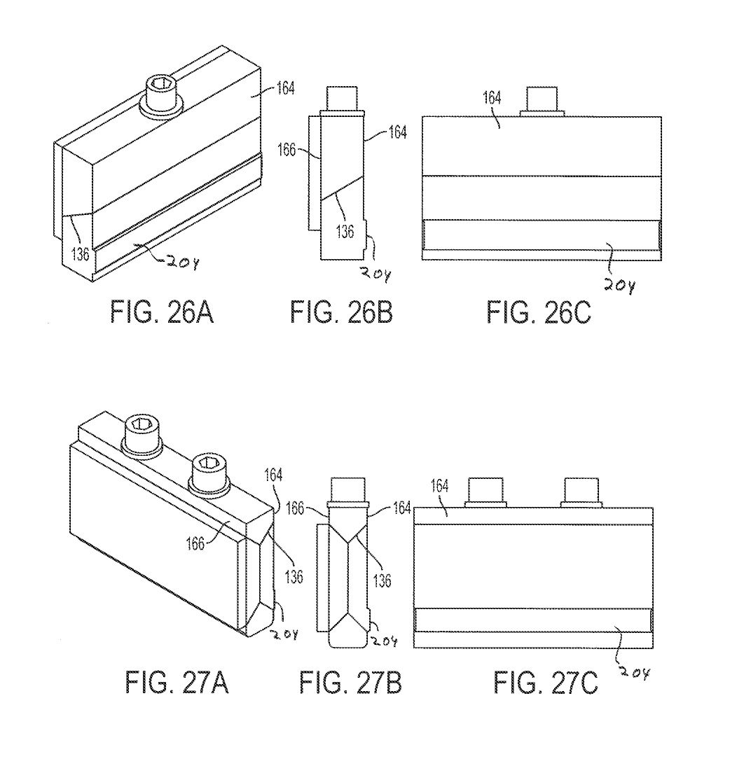

As alluded to earlier in this description, in other embodiments, the projection from the side of the lower block of the clamp assembly can take other forms. FIGS. 25A through 27C illustrate clamp assemblies where the lower blocks includes protrusions provided either by a threaded rectangular solid, received in an opening in the lower block, that extends from the lower block (see FIGS. 25A and 25B), or where the protrusion is molded into and extends completely across the lower block (see FIGS. 26A through 27C).

In the alternate embodiments shown in FIGS. 26A through 27C, the clamp assembly can include either only two blocks, as shown in FIGS. 26A and 26B, or four or more blocks, as shown in FIGS. 27A, 27B and 27C. In FIGS. 26A and 26B, the two blocks slide relative to each other, so that the protrusion is pressed into and held by the protrusion receiving groove. In FIGS. 27A, 27B and 27C, the center block is split into two blocks, with the upper and lower blocks having wedge shaped surfaces which serve to split the center block, forcing the center block in opposite outward directions. In this embodiment, the protrusion which is received in the protrusion receiving groove is formed into one of the two portions of the center block.

In each of the protrusion clamp assemblies of FIGS. 26A through 27C, it is noted that as the clamp assembly is tightened, the respective protrusion is forced into the respective protrusion receiving groove, so as to hold the clamp assembly in the groove to prevent the clamp assembly from being withdrawn from the shoe in a panel withdrawal direction.

While the invention has been described with reference to preferred embodiments, it is to be understood that the invention is not intended to be limited to the specific embodiments set forth above. Thus, it is recognized that those skilled in the art will appreciate that certain substitutions, alterations, modifications, and omissions may be made without departing from the spirit or intent of the invention. For example, the projection could be formed in the shoe, and the groove in one of the clamp blocks, rather than as described above. Accordingly, the foregoing description is meant to be exemplary only, the invention is to be taken as including all reasonable equivalents to the subject matter of the invention, and should not limit the scope of the invention set forth in the following claims.

What is claimed is:

1. A partition mounting system for mounting a partition including a lower edge and a first side generally parallel to and spaced apart from a second opposite side adjacent to the lower edge, the system comprising;
a shoe with an upward opening slot defined by a pair of spaced apart opposing side walls and a lower wall, the slot sized to receive the lower edge of the partition with each side of the partition adjacent to one of the side walls of the shoe and the lower edge of the partition adjacent to the lower wall of the shoe;
a clamp assembly positioned between the second side of the partition and its adjacent side wall of the shoe, the clamp assembly having a lower block, a center block, positioned above the lower block, an upper block positioned above a center block, and a screw extending generally vertically through the upper and center blocks and threadedly engaged by the lower block; and
the center block having a sloped upper surface and a sloped lower surface, the upper block having a lower surface engaging the sloped upper surface and the lower block having an upper surface engaging the sloped lower surface;
wherein rotation of the screw in a first direction draws the upper and lower blocks toward each other and the engagement between the upper block and the center block and the lower block and the center block operate to force an engagement surface of the center block against one of the side wall of the shoe and the side of the partition, and to force an engagement surface of the upper block and an engagement surface of the lower block against the other of the side wall and the side, the lower block including a projection on the side thereof facing a shoe sidewall, and
wherein the shoe sidewall face adjacent to the lower block has a groove capable of receiving a projection therein so that when the projection is received in the groove, the lower block is not movable in a partition-withdrawal direction across the shoe sidewall face.

2. A shoe for use with a clamp assembly for a partition mounting system, the system including a partition having a lower edge and a first side generally parallel to and spaced apart from a second opposite side adjacent to the lower edge, the clamp assembly having a lower block, an upper block having a sloped lower surface and positioned above the lower block, and means for drawing the upper and lower blocks toward each other, such that the blocks cooperate to exert a generally horizontal force against the one of the sides of the partition and the side wall of the slot, and the lower block including a captured nut, the nut having a nut corner that protrudes from the lower block, the shoe comprising:
an upward opening slot defined by a pair of spaced apart opposing side walls and a lower wall, the slot sized to receive the lower edge of the partition with each side of the partition adjacent to one of the side walls of the shoe and the lower edge of the partition adjacent to the lower wall of the shoe, the shoe capable of receiving the clamp assembly between the second side of the partition and its adjacent side wall of the shoe;
the shoe sidewall face adjacent to the lower block having a groove capable of receiving the nut corner therein so that when the nut corner is received in the groove, the lower block is not movable in a partition-withdrawal direction across the shoe sidewall face.

3. A partition mounting system in accordance with claim 2 wherein both shoe inside sidewall faces include a groove capable of receiving a nut corner therein.

4. A partition mounting system in accordance with claim 2 wherein the nut is captured in a lower block nut-receiving opening, the opening being configured to prevent rotation of the nut within the nut-receiving opening.

5. A partition mounting system in accordance with claim 2 wherein the drawing means comprises a screw extending generally vertically through the upper block and threadedly engaging the lower block, such that rotation of the screw in a first direction draws the upper and lower blocks toward each other and the blocks cooperate to exert the generally horizontal force, and wherein the nut is threaded on the screw.

6. A clamp assembly for a partition mounting system, the system including a partition including a lower edge and a first side generally parallel to and spaced apart from a second opposite side adjacent to the lower edge, a shoe with an upward opening slot defined by a pair of spaced apart opposing side walls and a lower wall, the slot sized to receive the lower edge of the partition with each side of the partition adjacent to one of the side walls of the shoe and the lower edge of the partition adjacent to the lower wall of the shoe, and a clamp assembly positioned between the second side of the partition and its adjacent side wall of the shoe, the clamp assembly comprising:
a lower block;
an upper block having a sloped lower surface and positioned above the lower block, and
means for drawing the upper and lower blocks toward each other, such that the blocks cooperate to exert a generally horizontal force against the one of the sides of the partition and the side wall of the slot,
the clamp assembly further including a panel edge receiving pocket adapted to receive and hold the bottom of the panel lower edge and the sides of the panel lower edge.

7. A partition mounting system in accordance with claim 5 wherein the pocket has a lower portion and spaced apart vertical portions attached to the lower portion, and wherein at least one side is tapered so that it presents a wider top opening for receiving the panel lower edge and a narrower bottom opening for holding the panel lower edge.
